(19) United States
(12) Patent Application Publication
(10) Pub. No.: US 2025/0319631 A1
(43) Pub. Date: Oct. 16, 2025

(54) METHOD FOR RECYCLING PLASTIC FILM

(71) Applicant: Sortology Ltd, Stockton-on-tees (GB)

(72) Inventor: James Donaldson, Stockton (GB)

(73) Assignee: Sortology Ltd, Stockton-on-tees (GB)

(21) Appl. No.: 18/289,846

(22) PCT Filed: May 6, 2022
(86) PCT No.: PCT/GB2022/051165

§ 371 Date: Nov. 7, 2023

(30) Foreign Application Priority Data
May 7, 2021 (GB) 2106578.4

(51) Int. Cl. B29B 17/00; B29B 17/02

(52) U.S. Cl. CPC B29B 17/0026; B29B 17/02; B29B 2017/0015; B29B 2017/0089; B29B 2017/0203; B29B 2017/0289; B29B 2017/0296

(57) ABSTRACT

This invention relates to a method for recycling plastics, e.g. plastic films.

This invention relates to a method for recycling plastics, e.g. plastic films.

### BACKGROUND

Very little post-consumer film is collected and recycled. In the UK, currently only 18 kT out of 900 kT of plastic film waste that is generated is recycled. These post-consumer plastic films are 70-80% polypropylene (PP) or polyethylene (PE), with the remaining portion being multi-layer plastic films, which often contain PP or PE. Nearly all post-consumer films are printed with inks. These inks, as well as post-consumer contamination such as food waste, makes the plastic films difficult to sort. In turn, this leads to poor quality recycled plastics that can only be used in a limited number of applications.

The presence of printing inks in the final recycled plastic is undesirable, as the inks and their degradation products can damage the quality of the resulting recycled plastic material. The inks and their degradation products can result in visible or physical imperfections, such as colour-tinged plastics, but they can also be hazardous to health. This makes the recycling of such printed plastic packaging materials difficult and can ultimately limit the recovered plastic material to low value markets.

“Perspectives in Boosting Value and Keeping Materials in the Economy”, as published by Ceflex in November 2020 (see

https://ceflex.eu/public_downloads/CEFLEX_QRP_Nov20_PUBLISHED.pdf
and
https://ceflex.eu/perspectives-in-boosting-value-and-keeping-materials-in-the-
economy/#:~:text=Perspectives%20in%20boosting%20value%20and%20keeping%20mat
erials%20in%20the%20economy,-
Dec%202%2C%202020&text=Collaborating%20together%20in%20the%20Sustainable,ap
plications%20than%20currently%20commercially%20available)

describes the conventional processes for recycling flexible plastic materials, such as plastic films. Such processes are generally split into three stages: sorting, washing, and extrusion. Sorting steps always occur prior to washing, such that separated material streams are sorted into bunkers, before each bunker of material is fed through a separate washing and extruding process. Such processes give rise to recycled plastics that are suitable for use in collation shrink or non-food packaging like pouches, small to medium sized bags, or BOPP film for pouches, bags or labels for non-food packaging applications. Processes, such as those described by Ceflex, have the potential to typically recover a maximum of 10-20% natural film depending on source.

### BRIEF SUMMARY OF THE DISCLOSURE

In accordance with the present invention there is provided a method of recycling plastic film, the method comprising:
a) exposing pieces of plastic film to an aqueous deinking solution comprising a surfactant and a base to produce pieces of deinked plastic film;
b) recovering the pieces of deinked plastic film from the deinking solution; and
c) sorting the deinked plastic film into a plurality of product classes.

The inventors have found that the method of the present invention allows for more accurate sorting of plastic films. By first deinking the plastic film, inks and/or other contaminants are less able to interfere with any analysis of the film that is used to sort the plastic film into a product class. This results in a purer recycled plastic being obtained, as the base material polymer and/or colour can be more accurately analysed and any plastic film that is insufficiently deinked can be removed. This is not possible in processes where sorting occurs prior to the deinking step. The inventors have found that these advantages result in an increase in the amount of plastic film that is converted into usable products during the recycling process. The amount of plastic film that is rejected and sent to non-recycled waste streams is reduced and the amount of post-consumer plastic film that is able to be re-used is increased. In part, this is because the quantity of end products that are of a suitably high quality to be used in high-grade plastic film applications, such as food packaging and flower-wrap, is increased.

The inventors have also found that an additional benefit of the sorting step occurring after the deinking step has occurred lies in the fact that the overall recycling process is streamlined. For example, existing processes, where the plastic film is sorted prior to deinking, require multiple concurrent processing streams performing the same operation for each sorted product class. The method of the present invention requires only a single processing stream for all steps prior to sorting. Therefore, in addition to the beneficial properties described herein for the resulting recycled plastic, the overall process is more efficient, and less equipment/processing space is required.

A further benefit is that the plastic film can be washed at the same time as it is de-inked, increasing the efficiency of the overall process. In existing processes, the film must be washed before it is sorted (and before the sorted material is deinked), meaning that the wash steps and deinking steps are separate. Adequate washing, particularly of post-consumer films, can only result from shredding of the plastic film prior to being washed (failure to minimise the size of the plastic film results in ‘balling up’ of the film, which prevents adequate cleaning and/or deinking). However, shredding the plastic film to obtain adequate cleaning results in the material being difficult to sort and so existing processes sort the material prior to shredding and/or washing/deinking to avoid this known problem.

### Deinking Solution

The surfactant may be any surfactant known to the skilled person that is suitable for removing inks from plastic film. The surfactant may be an ionic surfactant, a non-ionic surfactant, or a combination thereof. The surfactant may be an anionic, cationic, or amphoteric surfactant, or any combination thereof.

Suitable non-ionic surfactants may be selected from alkyl polyalkylene glycol ethers, and NP(EO)₁₀.

A suitable amphoteric surfactant may be dimethyl dodecylamine oxide (DDAO).

Suitable anionic surfactants may be selected from alkyl sulfate salts. The alkyl sulfate salt may be sodium dodecyl sulfate.

Suitable cationic surfactants may be selected from tetraalkylammonium salts. The tetraalkylammonium salt may be selected from hexadecyltrimethylammonium bromide (CTAB), Hexadecylpyridinium chloride (CPC), trimethylhexadecylammonium chloride, and dodecyltrimethylammonium bromide.

The deinking solution may comprise a single surfactant. Alternatively, the deinking solution may comprise a mixture of more than one surfactant.

The surfactant may be a trialkyl hydroxyalkyl ammonium salt.

The trialkyl hydroxyalkyl ammonium salt surfactant may have a structure according to formula (I):

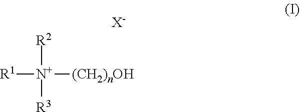

wherein
R¹ is selected from C₈-C₂₀ alkyl, —CH₂Ph, and —(CH₂)ₙOH;
R² is C₁-C₆ alkyl;
R³ is C₁-C₆ alkyl;
X⁻ is an anion; and
n is selected from 2, 3, 4, 5, or 6.

The deinking solution may comprise a single trialkyl hydroxyalkyl ammonium salt surfactant. Alternatively, the deinking solution may comprise a mixture of more than one trialkyl hydroxyalkyl ammonium salt surfactants. Thus, the deinking solution may comprise a surfactant of formula (I). Alternatively, the deinking solution may comprise a mixture of more than one surfactant of formula (I).

In an embodiment, R¹ is —CH₂Ph. In an embodiment R¹ is —(CH₂)ₙOH.

In an embodiment, R¹ may be C₈-C₂₀ alkyl. In an embodiment, R¹ may be C₁₁-C₁₈ alkyl, preferably R¹ may be C₁₂-C₁₄ alkyl. In an embodiment R¹ is C₁₂ alkyl. In an embodiment, R¹ is C₁₄ alkyl.

In an embodiment, the deinking solution may comprise a mixture of surfactants having R¹ with a range of alkyl chain lengths selected from C₈ to C₂₀. The deinking solution may comprise a mixture of surfactants having R¹ with a range of alkyl chain lengths selected from C₁₁ to C₁₈. The deinking solution may comprise a mixture of surfactants having R¹ with a range of alkyl chain lengths selected from C₁₂ to C₁₄. For example, the deinking solution may comprise both a surfactant with R¹ being C₁₂ alkyl and a surfactant with R¹ being C₁₄ alkyl.

In an embodiment, R² may be C₁-C₃ alkyl, preferably R² may be C₁ alkyl. In an embodiment, R³ may be C₁-C₃ alkyl, preferably R³ may be C₁ alkyl. In an embodiment, both R² and R³ are C₁-C₃ alkyl. In an embodiment, both R² and R³ are C₁ alkyl.

In an embodiment, X⁻ is selected from halide (F⁻, Cl⁻, Br⁻, I⁻), hydroxide (⁻OH), and sulphate (SO₄⁻). In an embodiment, X⁻ is selected from fluoride (F⁻), chloride (Cl⁻), bromide (Br⁻), and iodide (I⁻). In an embodiment, X⁻ is chloride.

In an embodiment, n is 2, or 3. In an embodiment, n is 2.

In an embodiment, R² and R³ are C₁-C₃ alkyl; X⁻ is selected from fluoride (F⁻), chloride (Cl⁻), bromide (Br⁻), and iodide (I⁻); and n is 2, or 3. In an embodiment, R² and R³ are each C₁ alkyl, i.e. methyl; X⁻ is chloride (Cl⁻); and n is 2.

In an embodiment, the surfactant has the structure according to formula (II):

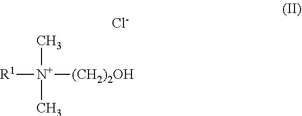

wherein R¹ is C₁₂-C₁₄ alkyl.

The surfactant (or mixture of surfactants) may be present in the deinking solution in an amount of from 0.025 wt % to 2 wt %. The surfactant (or mixture of surfactants) may be present in the deinking solution in an amount of from 0.05 wt % to 1.5 wt %, optionally from 0.05 wt % to 1 wt %, from 0.05 wt % to 0.6 wt %, from 0.1 wt % to 0.5 wt %, or from 0.115 wt % to 0.3 wt %. The surfactant (or mixture of surfactants) may be present in the deinking solution in an amount of 0.3 wt %.

The base may be any inorganic base. The base may comprise an alkali earth metal cation and an anion selected from hydroxide and carbonate. The base may be selected from LiOH, NaOH, KOH, Na₂CO₃, NaHCO₃, K₂CO₃, and KHCO₃. The base may be selected from LiOH, NaOH, and KOH. The base may be NaOH or KOH. The base may be both NaOH and KOH. The base may be NaOH. The base may be KOH.

The base may be present in the deinking solution in an amount of from 0.5 wt % to 10 wt %. The base may be present in the deinking solution in an amount of from 1 wt % to 10 wt %, optionally from 2 wt % to 6 wt %.

The deinking solution may contain one or more further additives. The additive may be selected from co-solvents, anionic detergent boosters, anti-foaming agents, and combinations thereof.

The anionic detergent booster may be any anionic detergent known to the skilled person. The anionic detergent booster may be any anionic detergent that is able to remove one or more non-ink substances from the plastic film.

The anionic detergent booster may be selected from sodium lauryl sulfate (SLS), sodium lauryl ether sulfate (SLES), ammonium lauryl sulfate (ALS), and combinations thereof. The anionic detergent booster may be sodium lauryl sulfate (SLS) or sodium lauryl ether sulfate (SLES). The presence of anionic detergent boosters may be particularly advantageous for deinking plastic films having a coating or lacquer. For example, where the plastic film has a polyvinylidene chloride (PVDC) or acrylic layer present. In addition to facilitating the improved deinking of the plastic film by the surfactant, the removal of coatings such as polyvinylidene chloride (PVDC) or acrylic layers results in a purer polymer product if the plastic is subsequently recycled.

The anionic detergent booster may be present in an amount of from 0.1 to 2 wt %. The anionic detergent booster may be present in an amount of from 0.25 to 1 wt %.

The anti-foaming agent may be any anti-foaming agent known to the skilled person. The anti-foaming agent may be selected from tributyl phosphate, copolymers of propylene oxide and ethylene oxide (e.g. Genapol® PF 40), alkylsisonoanamide (Prevol 3472 N), and polydimethylsilicone based anti-foaming agents. The anti-foaming agent may be present in the deinking solution in an amount sufficient to prevent foaming of the deinking solution. Thus, the anti-foaming agent may be present in an amount of from 0.01 to 1 wt %. Preferably, the anti-foaming agent is present in an amount of from 0.01 to 0.05 wt %.

### Plastic Film

The pieces of plastic film will typically be a mixture of different types of plastic film.

The mixture of plastic films may comprise any plastic film having an ink-printed surface.

The mixture of plastic films may comprise a polyolefin plastic film. The mixture of plastic films may comprise any one or more of: a Biaxially Orientated PP (BOPP) film, a polypropylene (PP) film, polyethylene (PE) film, a low-density polyethylene (LDPE) film, a polyethylene terephthalate (PET) film.

The mixture of plastic films may comprise multilayer film.

The mixture of plastic films may comprise more than one type of plastic film. The mixture of plastic films may comprise plastic films made from different polymers. For example, the mixture of plastic films may comprise an amount of Biaxially Orientated PP (BOPP) film, polypropylene (PP) film, polyethylene (PE) film, low-density polyethylene (LDPE) film, and/or polyethylene terephthalate (PET) film.

The mixture of plastic films may comprise an amount of polyethylene film and an amount of one or more other plastic films described herein. The mixture of plastic films may comprise an amount of polypropylene film and an amount of one or more other plastic films described herein. The mixture of plastic films may comprise an amount of polyethylene film and an amount of polypropylene film.

The plastic film may comprise a coating or lacquer. The film may comprise a polyvinylidene chloride (PVDC) or acrylic layer present.

Each of the pieces of plastic film may be a packaging film obtained following use by a consumer, i.e. a post-consumer film. The plastic film may be a bottle label, film lid, sheath, bag (including bread bags and carrier bags), sachet, or any other plastic film packaging item.

The pieces of plastic film may be obtained from an energy recovery facility (ERF) or material reclamation facility (MRF). The pieces of plastic film may comprise plastic film obtained from an ERF and/or MRF and/or other post-consumer film.

The pieces of plastic film may be post-industrial plastic film. Post-industrial plastic films are those that are recovered following production of the film, i.e. no-consumer use (including food exposure) of the plastic film has taken place.

The method of the present invention may be performed on pieces of plastic film only, i.e. where the only plastic material present in steps a-c are plastic films. For example, the method of the present invention may be performed in the absence of a bottle from which the film bottle label has been previously removed. In other words, the method of the present invention may exclude the simultaneous deinking of plastic film and removal of plastic film from a further substrate, e.g. a plastic bottle or additional plastic film layer.

The film may not be a laminate film.

The film may have a thickness of from 20 microns to 500 microns. The film may have a thickness of from 20 microns to 150 microns.

The ink(s) present on the plastic film can be any type of ink used for printing on to plastic films. The ink(s) include flexographic inks, UV stabilised inks, and specialised printing inks such as digi-marking for food grade plastic identification. The inks may be acrylic-based inks, pentaerythritol-based inks, resin acid inks, rosin acid inks, or combinations thereof. The ink(s) may be acrylic-based inks, pentaerythritol-based inks, or combinations thereof. The ink(s) may be acrylic-based inks.

Each piece of plastic film may be deinked without any prior size-modifying step. For example, an entire bottle label, film lid, sheath, bag (including bread bags and carrier bags), sachet, or any other plastic film packaging item may be exposed to the deinking solution.

Each of the pieces of plastic film may have a length and width in the range of from 1 cm to 30 cm, from 5 cm to 20 cm, or from 5 cm to 15 cm. Each of the pieces of plastic film may have a length and width of approximately 10 cm by 10 cm. Plastic films of this size are able to be sorted easily following the deinking step (step a), whilst maximising the removal of ink during the deinking step.

The inventors have found that where each plastic film has a length and width of at least 8 cm by 8 cm this may also result in improved sorting of the plastic films following the deinking step.

Each plastic film may be modified to fall within these dimensions prior to being exposed to the deinking solution. Thus, the method may comprise a step in which the plastic film is processed to have a size falling within the ranges described herein. This may be a cutting and/or grinding step.

By using plastic films having dimensions as disclosed herein, the method of the present invention is able to maximise the amount of plastic film that is recovered when the pieces of deinked plastic film are sorted in to different product classes. The improved efficiency of the deinking step of the present invention enables the plastic film to be larger than is possible in conventional processes, where plastic films are ground to dimensions of approximately 2 to 3 cm, to maximise cleaning and deinking of the plastic film. Such finely ground materials are not able to be subsequently sorted and so a recycled plastic of lower purity is obtained. Accordingly, the method of the present invention is able to recover up to three times more plastic film than conventional processes.

A deinked plastic film according to the present invention is any plastic film defined herein, wherein the amount of ink present on the plastic film following the deinking step is less than the amount of ink on the plastic film prior to exposure to the deinking solution.

The amount of ink remaining on a deinked plastic film may be less than 70%, less than 60%, less than 50%, less than 40%, less than 30%, less than 20%, or less than 10% of the amount of ink present on the plastic film prior to being exposed to the deinking solution. The ink may be completely removed from the plastic film, i.e. the plastic film may be fully deinked.

The step of exposing pieces of plastic film to an aqueous deinking solution, i.e. step a), may further involve immersing the pieces of plastic film in a volume of the aqueous deinking solution.

The step of exposing the pieces of plastic film to the aqueous deinking solution may comprise forming a mixture of aqueous deinking solution and plastic film.

Step a) may further comprise mechanically agitating the mixture of plastic film and deinking solution.

Mechanically agitating the mixture of deinking solution and plastic film may increase the deinking of the plastic film, i.e increase the amount of ink removed from the plastic film. Mechanical agitation typically occurs at a rate and amount sufficient to facilitate physical contact between a plurality of plastic films within the mixture of deinking solution and plastic film or between the plastic film and an abrasive article that is also present in the mixture. The abrasive article may be a rubber or plastic article.

The mechanical agitation may comprise stirring the mixture of deinking solution and pieces of plastic film. For example, batch rotating mixers may be used to provide the mechanical agitation.

The deinking solution should be in contact with the plastic film for a period of time sufficient to maximise the removal of ink from the film, whilst maintaining an economical use of the surfactant.

The step of exposing the plastic film to the deinking solution may occur for a period of 30 minutes or less, or 20 minutes or less. Preferably, the step of exposing the plastic film to the deinking solution occurs for a period of 10 minutes or less.

The temperature of the aqueous deinking solution is proportional to the robustness of the ink that is present on the plastic film. For example, a more robust ink may require a higher temperature in order to be removed from the plastic film.

The aqueous deinking solution may be at a temperature of from 35° C. to 90° C., optionally at a temperature of from 50° C. to 90° C., further optionally from 75° C. to 90° C.

The ratio of plastic film to deinking solution may be from 15 to 750 kg of plastic film per tonne of deinking solution. The ratio of plastic film to deinking solution may be from 30 to 60 kg of plastic substrate per tonne of deinking solution.

The ratio of plastic substrate to deinking solution may be from 2:1 to 1:2 by mass.

The process may comprise an initial wash step to remove contaminants, such as food waste.

The deinking solution may advantageously also remove food waste or other contaminants from the plastic film, removing the requirement for additional or separate washing of the plastic film.

### Recovering the Pieces of Deinked Plastic Film

The step of recovering the pieces of deinked plastic film may comprise removing the pieces of deinked plastic film from a volume of the deinking solution. The step of recovering the pieces of deinked plastic film may comprise removing the deinking solution from the pieces of deinked plastic film. The deinking solution may be removed from the pieces of deinked plastic with high centrifugal spinners or vibrating screens.

### Sorting

The recovered pieces of deinked plastic film are sorted into different product classes. The pieces of deinked plastic film may be sorted according to base material. The base material may be distinguished by the polymer that forms the plastic film. For example, PP, PE, LDPE, PET may be sorted in to different product classes. The base material may be further distinguished by colour of the base material. For example, each PP, PE, LDPE, PET product class may also be sorted by pigments within the plastic film to create a coloured product class for each polymer.

The pieces of deinked plastic film may be sorted according to the level of deinking that has occurred in step a). Plastic film that has been fully deinked may be sorted in to a product class. Separating plastic film that has been fully deinked from plastic film that has not been fully deinked results in a product class that is devoid of the inks that can result in visual or physical defects in the recycled plastic material and/or that are free from hazardous products associated with the inks or their breakdown products.

This represents a significant advantage of the invention. By first exposing pieces of plastic film to an aqueous deinking solution and subsequently sorting the deinked films by removing films that have not been fully deinked, the resulting recycled plastic is purer than can be obtained in processes where the plastic films are sorted in to product classes prior to deinking. Thus, the resulting recycled plastic can be used for applications requiring a higher quality plastic, such as food packaging, or applications where the visual effects of ink-incorporation are detrimental, such as where a clear or white plastic is required, e.g. flower wrap or labels.

The pieces of deinked plastic film may be sorted using any conventional sorting process. The pieces of deinked plastic film may be sorted using a system comprising one or more of an acceleration belt, a near-infrared (NIR) camera, and colour camera, and a compressed air ejection system. The system may also be equipped with film stabilisation to aid the sorting of the plastic films. Such film stabilisation may be achieved by exposing the acceleration belt to a tunnel of air travelling along the belt at the same speed as the belt.

The pieces of deinked plastic film may be sorted in to one or more of the following product classes: polypropylene film, polyethylene film, or film of any material that has not been fully deinked.

### Post Deinking Steps

The method may further comprise the step of isolating one or more product class from the sorting step and independently extruding the pieces of deinked plastic film in that product class to form a recycled plastic product. The recycled plastic product may be pellets. The step of extruding the recycled plastic product may comprise heating the deinked plastic film within a product class to a temperature sufficient to melt the plastic film and passing the melted plastic film through a die.

The method may further comprise the step of deodorising the molten plastic film and/or the plastic pellets obtained from the extruding step. The step of deodorising may comprise degassing the molten plastic film, exposing the molten plastic film to an air flow, passing the molten plastic film through a filter, or any combination thereof.

The extruding and deodorising steps may be performed by commercially available systems, such as the INTAREMA® TVEplus® system and/or the ReFresher system, available from EREMA Engineering Recycling, Austria.

Ink that is removed from the pieces of plastic film can contaminate the deinking solution and prevent continued or further use of the deinking solution for deinking the pieces of plastic film. Accordingly, inks may be removed from the deinking solution to regenerate the deinking solution.

The method may further comprise the step of regenerating the deinking solution. The step of regenerating the deinking solution may comprise centrifugation and/or filtration of the deinking solution. Filtration of the deinking solution may comprise filtration through candle filters, activated charcoal, diatomaceous earth, or any combination thereof.

The step of regenerating the deinking solution may occur simultaneously or sequentially to the step of exposing the pieces of plastic film to the deinking solution. Where the step of regenerating the deinking solution occurs simultaneously, a portion of the deinking solution may be continually removed from the volume of deinking solution and exposed to the centrifugation and/or filtration processes described herein. Regenerated deinking solution, i.e. deinking solution substantially free of ink, may be returned to the volume of deinking solution being used in exposing step. Alternatively, the deinking solution may be regenerated in batches after a predetermined time and/or quantity of plastic film has been deinked by the deinking solution.

According to a second aspect, the present invention provides a recycled plastic product obtainable by the method of the first aspect. The recycled plastic product may be obtained by melting the deinked plastic film contained within a product class obtained from the sorting step to form a molten plastic film, and passing said molten plastic film through a die.

### BRIEF DESCRIPTION OF THE DRAWINGS

Embodiments of the invention are further described hereinafter with reference to the accompanying drawings, in which:

FIG. 1 shows the composition of post-consumer plastic film after being deinked but prior to being sorted, as described in examples 1 and 2.

FIG. 2 shows the composition of the input stream described in example 3. ‘ML+PP’ denotes multilayer and polypropylene film. ‘Black’ denotes black LDPE film. ‘White’ denotes white LDPE film. ‘Clear’ denotes a mix of multilayer polypropylene and polypropylene. ‘Colour’ denotes LDPE film of any non-white, non-black, and non-clear LDPE film.

### DETAILED DESCRIPTION

The terms ‘deink’, ‘removal of ink’, and ‘ink removal’ are used interchangeably throughout this description to refer to the permanent separation of ink from a plastic film.

A deinked plastic substrate according to the present invention is any plastic substrate defined herein, wherein the amount of ink present on the plastic substrate is less than the amount of ink on the plastic substrate prior to it being exposed to the deinking solution.

The amount of ink remaining on a deinked plastic substrate may be less than 70%, less than 60%, less than 50%, less than 40%, less than 30%, less than 20%, or less than 10% of the amount of ink present on the plastic substrate prior to being exposed to the deinking solution. The ink may be completely removed from the plastic substrate, i.e. the plastic substrate may be fully deinked.

The amount of ink remaining on the deinked plastic may be determined by comparing the dry weight of the plastic substrate before and after the deinking has occurred. The amount of ink remaining on the deinked plastic may be determined by using a volatile solvent (such as acetone or IPA) to strip the surface of the plastic substrate. After stripping, both the solvent and the cleaned substrate are dried and the weight of removed ink is determined by the average weight loss of the plastic substrate and the weight of ink recovered

‘Pieces’ as used herein refer to a plurality of plastic films. The pieces may be a mixture of different types of plastic film. The types of film may include different polymers, densities, colours, have different amounts of ink printed on them, or any combination of these properties.

For the avoidance of doubt, and unless otherwise explicitly disclosed (such as in the case of a deinked or fully deinked plastic film) a plastic film is a film comprising any non-zero amount of ink on at least one of its surfaces.

The term ‘exposing the plastic film to an aqueous deinking solution’, or variants thereof, means that the deinking solution is brought into contact with the plastic film.

The terms ‘robust ink’, ‘more robust ink’, or ‘less robust ink’ refer to the relative strength of adhesion of an ink to the surface of the plastic substrate. A ‘more robust ink’ will have a greater adhesion to a plastic substrate than a ‘less robust ink’.

The term ‘alkyl’, as used herein, refers to a linear or branched hydrocarbon chain. For example, the term ‘C₁₋₆ alkyl’ refers to a linear or branched hydrocarbon chain containing 1, 2, 3, 4, 5 or 6 carbon atoms.

Typically, the term ‘alkyl’ refers to a linear hydrocarbon chain comprising from 8 to 20 carbon atoms. Typically, alkyl chains are unsubstituted, except where, in certain circumstances, an alkyl group may be substituted with a phenyl or hydroxy group.

A trialkyl hydroxyalkyl ammonium salt, as used herein, refers to a salt comprising a quaternary ammonium cation having three alkyl chains and one hydroxyalkyl chain, and an anion. A trialkyl hydroxyalkyl ammonium salt, as used herein, may also refer to a salt comprising a quaternary ammonium cation having three alkyl chains and one hydroxyalkyl chain, and an anion, wherein any one of the three alkyl chains may be substituted with a phenyl or hydroxy group.

A polyolefin, as used herein, refers to any polymer formed from alkene monomer units, i.e. any linear or cyclic hydrocarbon having one or more carbon-carbon double bonds.

A multilayer film, as used herein, is a laminated structure comprising one or more layers of material, each independently selected from PE,PP, Nylon, PVDC, PET, and aluminium.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

### EXAMPLES

### Example 1

Deinking of post-consumer plastic film was performed on 40 kg of material. The components of this material were as described in Table 1:

TABLE 1

| MATERIAL | % |
|---|---|
| Colored - no ink - labels | 1.4 |
| Colored - no ink | 5.5 |
| Colored - little ink - labels | 4.1 |
| Colored - little ink | 8.2 |
| Colored - much ink - labels | 0.4 |
| Colored - much ink | 20.5 |
| Clear - no ink - labels | 1.8 |
| Clear - no ink | 9.8 |
| Clear - little ink - labels | 1.2 |
| Clear - little ink | 8.9 |
| Clear - much ink - labels | 0.4 |
| Clear - much ink | 35.1 |
| Metalized Film | 2.3 |
| Net | 0.5 |
| TOTAL | 100.0 |

This material, without shredding, was washed, under the following conditions:

| Washing water (I) | 1000 L |
|---|---|
| NaOH (wt %) | 5% |
| Surfactant (wt %) | Hydroxyethyl laurdimonium chloride (40 |
| | wt % solution) 0.3 wt % |
| Temperature (° C.) | 60 |
| Time (min) | 10 |

Although de-inking did occur with this process, the material ‘balled up’ in the reactor. Therefore, the material was shredded through a 150 mm screen and rewashed under the same conditions, as below:

| Washing water (I) | 1000 L |
|---|---|
| NaOH (wt %) | 5% |
| Surfactant (wt %) | Praepagen HY/Hydroxyethyl |
| | laurdimonium chloride |
| | (40 wt % solution) 0.3 wt % |
| Temperature (° C.) | 60 |
| Time (min) | 10 |

The washed film was analysed and subjected to sorting, as described in Example 2.

### Example 2

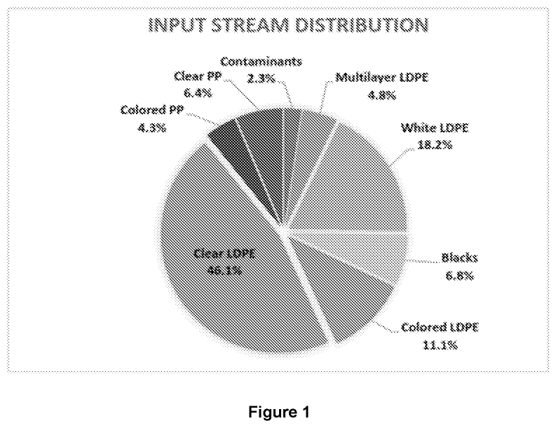

The material obtained from the deinking process of Example 1 was analysed prior to sorting. The composition of the material obtained following deinking is shown in FIG. 1.

The maximum amount of clear film available for sorting is now 52.5% (46.1% Clear LDPE and 6.4% clear PP), while white films account for 18% (of the input material).

Conventional processes, where sorting occurs prior to deinking, would allow only the clear material to be sorted. From Table 1, it can be calculated that such processes would allow only 11.6% of the material to be recovered (1.8% ‘clear—no ink—labels’ and 9.8% ‘clear—no ink’). Thus, the deinking process of Example 1 results in approximately five times for more natural film being available for recovery compared to conventional processes, where deinking is performed following a sorting step.

The input material was sorted using NIR sorters, as described herein, and subject to analysis. The sorted material was analysed to provide overall sorting efficiencies for the process. This sorting process aimed to remove everything from the LDPE, giving rise to an LDPE product class (Box 1 negative).

| | | Multilayer | White | | Colored | Clear | | |
|---|---|---|---|---|---|---|---|---|
| | Contaminants | LDPE | LDPE | Blacks | LDPE | LDPE | Total | Purity |
| Box 2 Positive (kg) | 1.451 | 0.3 | 0.248 | 0.12 | 0.172 | 0.39 | 2.681 | |
| Box 1 Negative (kg) | 0.3 | 0.342 | 2.18 | 0.79 | 1.31 | 5.77 | 10.692 | 94.0% |
| Total | 1.751 | 0.642 | 2.428 | 0.91 | 1.482 | 6.16 | 13.373 | |
| Efficiencies | 82.9% | 46.7% | | | | | | |

| | |
|---|---|
| Global Efficiency | 73.2% |

The Global efficiency for recovery of LDPE is 73.2% and the resulting purity of the sorted product class is 94% LDPE.

Repeating such tests for the different sort fractions allows a prediction of the final sorted quality and then number of primary and resorting machines to be defined.

The film purities obtained in the trials were sufficient to meet the standard target specifications for the film extrusion systems. Small scale Melt flow index strands were made from the cleaned film and these were smooth and without gas bubbles of physical inclusions. These attributes are indicators of good quality.

### Example 3: De-Inking and Compounding of Plastic Film Obtained from a Material Reclamation Facility (MRF)

Around 50 kg of dirty post-consumer film was extracted from an MRF. This dirt and grease contamination on the film was tested (by a hot water wash on a small sample) and was found to be about 5% by weight of the sample.

The first stage was to size reduce the material. This was done using an open-rotor granulating instrument with a 160 mm by 180 mm rectangular screen in it. After size reduction around 70% of the material (by weight) was in the size range 10-30 mm square.

The granulated material was loaded into a Stainless Steel slow rotating reactor with 1000 litres of water, comprising 3% NaOH and 0.3% surfactant (Praepagen HY/Hydroxyethyl laurdimonium chloride (40 wt % solution) 0.3 wt %), at 60° C. The vessel was rotated for 10 minutes and then emptied. The film was extracted by a vibrating screen from the water and then the film was then washed (in the same reactor) twice with clean water to rinse away any NaOH solution. The film was then dried to <4% moisture using hot air. Around 8-15% of film weight was lost and this loss is attributed to dirt, ink removal and other process losses.

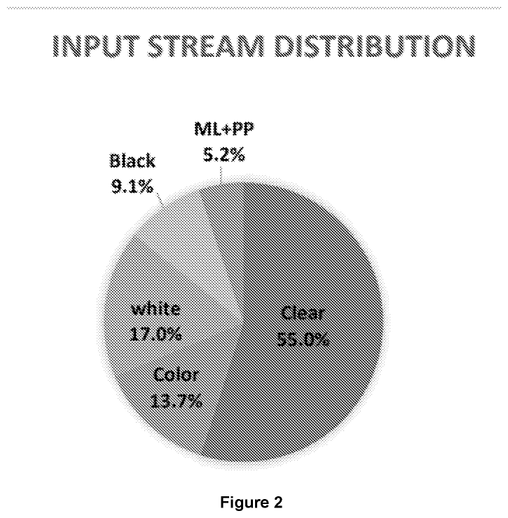

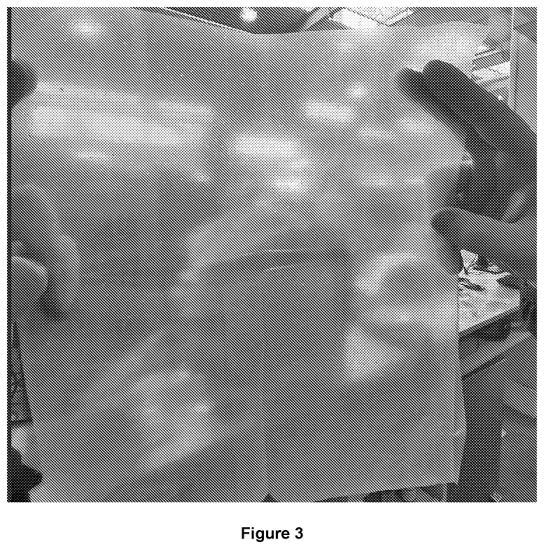

After washing, the film was sorted using a 2 m Pellenc Mistral+Film sorter. The source input stream for this process is shown in FIG. 2.

The deinked film was sorted and 90% of the available film was extracted into a ‘clear fraction’ (i.e. deinked fraction) with 98% purity (using 3 sorting actions in total and 2 resorting actions). The results of, one batch, of the final sort are shown below:

| | Clear | Colour | White | Black | ML + PP | Total | Purity |
|---|---|---|---|---|---|---|---|
| Box 2 Positive (kg) | 0.35 | 0.01 | 0.07 | 0.035 | 0.017 | 0.482 | |
| Box 1 Negative (kg) | 2 | 0.003 | 0.02 | 0.01 | 0 | 2.033 | 98.4% |

The resulting LDPE film was pelletised on a Leistritz 40 mm extruder. The pelletised film was then used to produce a 45 micron film, blown at 100% recycled content. The extrusion process was performed without filtration and the film still showed very few block spots and other dirty type contamination. The resulting film is shown in FIG. 3, where it is apparent that a clear film product was produced by this process.

1. A method of recycling plastic film, the method comprising:
a) exposing pieces of plastic film to an aqueous deinking solution comprising a surfactant and a base to produce pieces of deinked plastic film;
b) recovering the pieces of deinked plastic film from the deinking solution; and
c) sorting the deinked plastic film into a plurality of product classes.

2. The method of claim 1, wherein each piece of plastic film has a length and width of at least 8 cm by 8 cm.

3. The method of claim 1 or claim 2, wherein step a) comprises immersing the pieces of plastic film in a volume of the aqueous deinking solution to form a mixture of aqueous deinking solution and pieces of plastic film.

4. The method of claim 3, wherein step a) further comprises mechanically agitating the mixture of deinking solution and pieces of plastic film to produce the pieces of deinked plastic film.

5. The method of any of claims 1 to 4, wherein step a) is performed for a period of 10 minutes or less.

6. The method of any preceding claim, wherein the sorting of deinked plastic film in step c) comprises sorting the deinked plastic film according to the base material of the plastic film.

7. The method of any preceding claim, wherein the sorting of deinked plastic film in step c) comprises sorting the deinked plastic film according to the level of deinking that has occurred in step a).

8. The method of any preceding claim, wherein the surfactant is a trialkyl hydroxyalkyl ammonium salt.

9. The method of any preceding claim, wherein the surfactant has a structure according to formula (II): 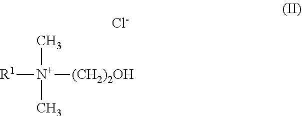
wherein R¹ is C₁₂-C₁₄ alkyl.

10. The method of any preceding claim, wherein the surfactant is present in the deinking solution in an amount of from 0.025 wt % to 2 wt %.

11. The method of any preceding claim, wherein the base is an inorganic base selected from LiOH, NaOH, KOH, Na₂CO₃, NaHCO₃, K₂CO₃, and KHCO₃;

12. The method of any preceding claim, wherein the base is NaOH.

13. The method of any preceding claim, wherein the base is present in the deinking solution in an amount of from 0.5 wt % to 10 wt %.

14. The method of any preceding claim, wherein the deinking solution further comprises an anionic detergent booster.

15. The method of any preceding claim, wherein the anionic detergent booster is selected from sodium lauryl sulfate (SLS), sodium lauryl ether sulfate (SLES), ammonium lauryl sulfate (ALS), and combinations thereof.

16. The method of any preceding claim, wherein the anionic detergent booster is present in an amount of from 0.1 to 2 wt %.

17. The method of any preceding claim, wherein the plastic film is selected from a polypropylene (PP), polyethylene (PE), and a low-density polyethylene (LDPE) film.

18. The method of any preceding claim, further comprising the step of isolating one or more product class from step c) and independently extruding the pieces of deinked plastic film in that product class to form a recycled plastic product.

19. The method of claim 8, wherein extruding the pieces of deinked plastic film comprises heating the deinked plastic film to a temperature sufficient to melt the plastic film to form a molten plastic film and passing the molten plastic film through a die.

20. A recycled plastic product, obtainable by the method of claim 18 or claim 19.
